(19) United States
(12) Patent Application Publication
(10) Pub. No.: US 2010/0174539 A1
(43) Pub. Date: Jul. 8, 2010

(54) METHOD AND APPARATUS FOR VECTOR QUANTIZATION CODEBOOK SEARCH

(75) Inventors: Rama Muralidhara Reddy Nandhimandalam, Andhra Pradesh (IN); Pengjun Huang, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/349,327

(22) Filed: Jan. 6, 2009

(51) Int. Cl. G10L 19/12

(52) U.S. Cl. 704/222; 704/E19.001

(57) ABSTRACT

A vector quantization codebook search method and apparatus use support vector machines (“SVMs”) to compute a hyperplane, where the hyperplane is used to separate codebook elements into a plurality of bins. During execution, a controller determines which of the plurality of bins contains a desired codebook element, and then searches the determined bin. Codebook search complexity is reduced and an exhaustive codebook search is selectively avoided.

### TECHNICAL FIELD

The present invention relates generally to vector quantization, and more particularly, to reducing vector quantization search complexity. Embodiments of the invention relate to codebook searching.

### BACKGROUND

In general, vector quantization is a quantization technique from signal processing that allows for the modeling of probability density functions by the distribution of prototype vectors. Vector quantization may be applied to signals, wherein a signal is a continuous or discrete function of at least one other parameter, such as time. A continuous signal may be an analog signal, and a discrete signal may be a digital signal, such as data. Hence, a signal may refer to a sequence or a waveform having a value at any time that is a real number or a real vector. A signal may refer to a picture or an image which has an amplitude that depends on a plurality of spatial coordinates (such as two spatial coordinates), instead of a time variable. A signal may also refer to a moving image where the amplitude is a function of two spatial variables and a time variable. A signal may also relate to abstract parameters having an application directed to a particular purpose. For example, in speech coding, a signal may refer to a sequence of parameters such as gain parameters, codebook index parameters, pitch parameters, and Linear Predictive Coding (“LPC”) parameters. A signal may also be characterized by an ability to be observed, stored and/or transmitted. Hence, a signal is often coded and/or transformed to suit a particular application. Unless directed otherwise, the terms signal and data are used interchangeably throughout.

Techniques associated with vector quantization evolved from communication theory and signal coding developed by Shannon, C. E., and described in “A Mathematical Theory of Communication,” Bell Syst. Tech. J., vol. 27, July 1948, pp. 379-423, 623-656. Hence in the literature, vector quantization may alternately be referred to as “source coding subject to a fidelity criterion.” Techniques associated with vector quantization are often applied to signal compression. If a signal can be can be perfectly reconstructed from the coded signal, then the signal coding is “noiseless coding” or “lossless coding.” If information is lost during coding, thereby prohibiting precise reconstruction, the coding is referred to as “lossy compression” or “lossy coding.” Techniques associated with lossy compression are often employed in speech, image, and video coding.

Techniques associated with vector quantization are often applied to signals obtained through digital conversion, such as conversion of an analog speech or music signals into a digital signal. Thus, the digital conversion process may be characterized by sampling, which discretizes the continuous time, and quantization, which reduces the infinite range of the sampled amplitudes to a finite set of possibilities. During sampling, a phenomenon occurs where different continuous signals may become indistinguishable (i.e. “aliases” of one another) when sampled. In order to prevent such an occurrence, it is generally accepted that the sampling frequency be chosen to be higher than twice the bandwidth or maximum component frequency. The maximum component frequency is also known as the Nyquist frequency. Hence, in traditional telephone service (also known as “POTS”), an analog speech signal is band-limited to 300 to 3400 Hz, and sampled at 8000 Hz. In order to conceptualize vector quantization, a brief summary of scalar quantization is provided.

FIG. 1 illustrates a graph 100 showing the input-output characteristics of an exemplary uniform scalar quantizer. During quantization, an input continuous-amplitude signal (e.g. a 16 bit digitized signal) is represented by the x axis and is converted to a discrete amplitude signal represented by the y axis. The difference between the input and output signal is known as “quantization error” or “noise,” and the distance between finite amplitude levels is known as the quantizer Δ 102. With reference to FIG. 1, it is apparent that input values between “4” and “5” on the x-axis are quantized to “5” on the y-axis and represented by the binary codeword “100.” Storage and/or transmission of the codeword represents significant compression when compared with the infinitely variable input data between “4” and “5.” In a uniform quantizer, the number of levels is generally chosen to be of the form 2^{B}, to efficiently use the B binary codewords, and Δ and B are chosen to cover the range of input samples. Thus, in a uniform quantizer, quantization error is typically reduced by increasing the number of bits.

FIG. 2 illustrates a graph 200 showing the input-output characteristics of an exemplary non-uniform scalar quantizer. In order to enhance the ratio of signal to quantization noise, for a given number of bits per sample, step sizes Δ 202 of the quantizer are typically selected to match a probability density function of a signal to be quantized. For example, speech-like signals do not have a uniform probability density function, with smaller amplitudes occurring much more frequently and having greater significance than higher amplitudes. FIG. 2 illustrates a non-uniform quantizer having a step sizes Δ that increase for higher input signal values. Hence, the codeword “111,” corresponding to input values between “7” and “8,” has a much greater step size A 202 than step size Δ 204 corresponding to codeword “100” because those values occur less frequently. This provides two main advantages. First, the speech probability density function is matched more accurately, thereby producing a higher signal to noise ratio. Second, lower amplitudes (which are illustrated about the origin of graph 200) contribute more to the intelligibility of speech and are hence quantized more accurately. In practice, speech generally follows a logarithmic scale. Hence, in 1972 the ITU Telecommunication Standardization Sector (ITU-T) defined two main logarithmic speech compression algorithms in standard ITU-T G.711. The two logarithmic algorithms are known as companded L-law (used in North America & Japan) and companded A-law (used in Europe and the rest of the world), and are generally characterized by a step size Δ that follows a logarithmic scale. According to the G.711 standard, the μ-law and A-law algorithms encode 14-bit and 13-bit signed linear PCM samples, respectively, to logarithmic 8-bit samples and thereby create a 64 kbit/s bitstream for a signal sampled at 8 kHz.

As set forth above, if the probability density function of an input signal (such as speech) is first estimated, then the quantization levels may be adjusted prior to quantization. This technique is known as “forward adaptation” and has the effect of reducing quantization noise. Some signals (such as speech) are highly correlated such that there are small differences between adjacent speech samples. For highly correlated signals, a quantizer may optionally encode the differences between input values (i.e. PCM values) and the predicted values. Such quantization techniques are called Differential (or Delta) pulse-code modulation (“DPCM”). Both concepts of adaptation and differential pulse-code modulation were standardized in 1990 by the ITU Telecommunication Standardization Sector (ITU-T) as the ITU-T ADPCM speech codec G.726. As commonly used, ITU-T G.726 is operated at 32 kbit/s, which provides an increase in network capacity of 100% over G.711.

### SUMMARY

An apparatus comprising a codebook comprising a plurality of codebook elements, wherein the elements are separated into a first search bin and a second search bin; and a searching module configured to determine whether a desired codebook element for an input vector is in the first search bin or the second search bin.

A method of searching a codebook comprising providing a mobile station codebook with a plurality of codebook elements, wherein the codebook elements are separated into a first search bin and a second search bin; determining whether a desired codebook element for an input vector is in the first search bin or the second search bin; and searching the determined search bin for the desired codebook element.

A computer readable medium containing software that, when executed, causes the computer to perform the acts of: providing a mobile station codebook with a plurality of codebook elements, wherein the codebook elements are separated into a first search bin and a second search bin; determining whether a desired codebook element for an input vector is in the first search bin or the second search bin; and searching the determined search bin for the desired codebook element.

A device, comprising means for providing a mobile station codebook with a plurality of codebook elements, wherein the codebook elements are separated into a first search bin and a second search bin; means for determining whether a desired codebook element for an input vector is in the first search bin or the second search bin; and means for searching the determined search bin for the speech codebook element.

A codebook product configured according to a process comprising: providing a plurality of codebook elements, wherein the codebook elements are separated into a first search bin and a second search bin; determining whether a speech desired codebook element for an input vector is in the first search bin or the second search bin; and searching the determined search bin for the speech desired codebook element.

### BRIEF DESCRIPTION OF DRAWINGS

FIG. 1 is a graph illustrating input-output characteristics of an exemplary uniform scalar quantizer.

FIG. 2 is a graph illustrating input-output characteristics of an exemplary non-uniform scalar quantizer.

FIG. 3 illustrates a schematic block diagram of a vector quantizer.

FIG. 4 is a graph illustrating a two dimensional codebook partitioned into a plurality of cells.

FIG. 5A is a graph illustrating sampling and quantization of an audio signal, such as speech.

FIG. 5B is a graph illustrating quantized samples associated with the audio signal of FIG. 5A.

FIG. 6A illustrates representative data to be quantized.

FIG. 6B illustrates the data of FIG. 6A partitioned into clusters.

FIG. 6C illustrates a search tree diagram corresponding to a search for a target input vector in FIG. 6B.

FIG. 6D illustrates a flow diagram corresponding to a search for the target input vector in FIGS. 6B and 6C.

FIG. 7A illustrates representative data in a codebook that can be partitioned using hyperplanes and support vectors.

FIG. 7B illustrates a codebook with a margin defined as a distance from a hyperplane to corresponding support vectors.

FIG. 7C illustrates a codebook with an optimized hyperplane.

FIG. 7D illustrates a reduction of search error when a function (hyperplane) determines a partition instead of a single point (centroid).

FIG. 8A illustrates a representative first minimum distance calculation in a binary codebook search.

FIG. 8B illustrates selection of a support vector set positioned below the hyperplane.

FIG. 9 is a block diagram illustrating a memory storing a codebook and a controller.

FIG. 10 is a flow diagram illustrating a process of searching a codebook.

FIG. 11 is a flow diagram illustrating a process of searching a codebook.

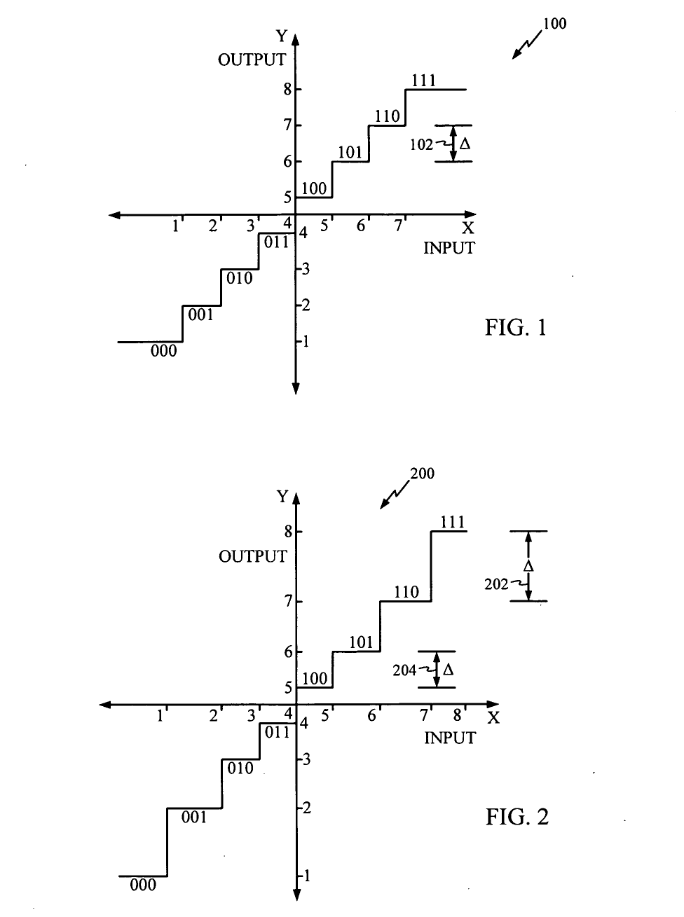

### DETAILED DESCRIPTION

Reference is made to the drawings wherein like parts are designated with like numerals throughout. More particularly, it is contemplated that the invention may be implemented in or associated with a variety of electronic devices such as, but not limited to, mobile telephones, wireless devices, and personal data assistants (“PDAs”).

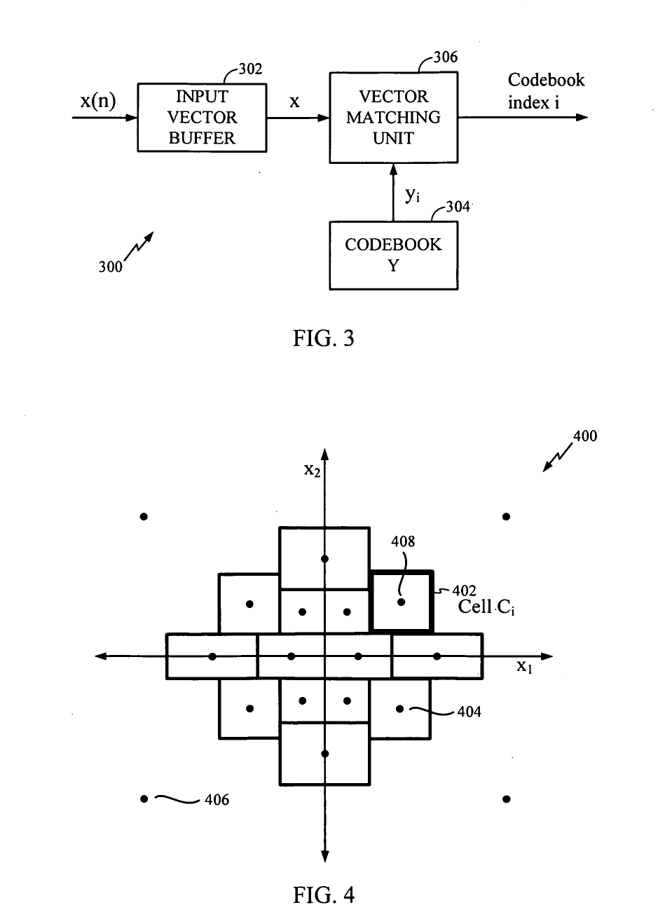

FIG. 3 illustrates a schematic block diagram of a vector quantizer 300. Vector quantization is alternately known as “block quantization” or “pattern-matching quantization.” In general, and as illustrated by FIG. 3, vector quantization provides for joint quantization of a set of discrete-parameter amplitude values as a single vector. A signal x(n) is buffered by input vector buffer 302 and output as an N dimensional vector x defined as follows:

x=[x₁,x₂, . . . ,x_{N}]^{T} EQ. 1

wherein T denotes a transpose in vector quantization. Variable x may be exemplified by real-valued, continuous-amplitude, randomly varying components xₖ, 1≦k≦N. Codebook 304 stores a set of codebook data Y (also known as “reference templates”), defined as follows:

Y=yᵢ=[yᵢ₁,yᵢ₂, . . . ,y_{iN}]^{T} EQ. 2

wherein L is the size of the codebook 304, and yᵢ are codebook vectors with 1≦i≦L. Vector matching unit 306 then compares vector x with a plurality of codebook entries yᵢ and outputs codebook index i. As set forth in greater detail below, there are a number of techniques to exhaustively or non-exhaustively search codebook 304 to determine the appropriate index i.

FIG. 4 is a graph 400 illustrating a two dimensional codebook partitioned into a plurality of cells. The abscissa is defined as x₁ and the ordinate is defined as x₂. In order to design a two-dimensional codebook, N dimensional space is partitioned into L regions or “cells” Cᵢ, 1≦i≦L. Vector yi is associated with each cell Cᵢ, and is represented by a centroid, such as centroids 404 and 406. As illustrated, each centroid is a dot centrally located within each cell Cᵢ. Of course, if the dimensional space N is equal to “1,” then vector quantization reduces to scalar quantization. During vector quantization, any input vector x that lies in cell Cᵢ 402 is quantized as yi. The codebook design process is also known as training or populating the codebook. It should be readily observed that cells Cᵢ may vary in shape to reflect two dimensional changes in step level Δ for purposes of codebook optimization, thereby providing an advantage over scalar quantization. For clarity in FIG. 4, values associated with the abscissa axis x₁ and the ordinate axis x₂ have been removed. However, it is readily apparent that cell 402 would encompass a range of values along the x₁ axis and a range of values along the x₂ axis.

Generally, values along the x₁ and x₂ axes and falling within cell 402 are defined as being clustered around centroid 408. When the two-dimensional space of FIG. 4 is expanded to an N-dimensional space, the feature of clustering data around a centroid is retained.

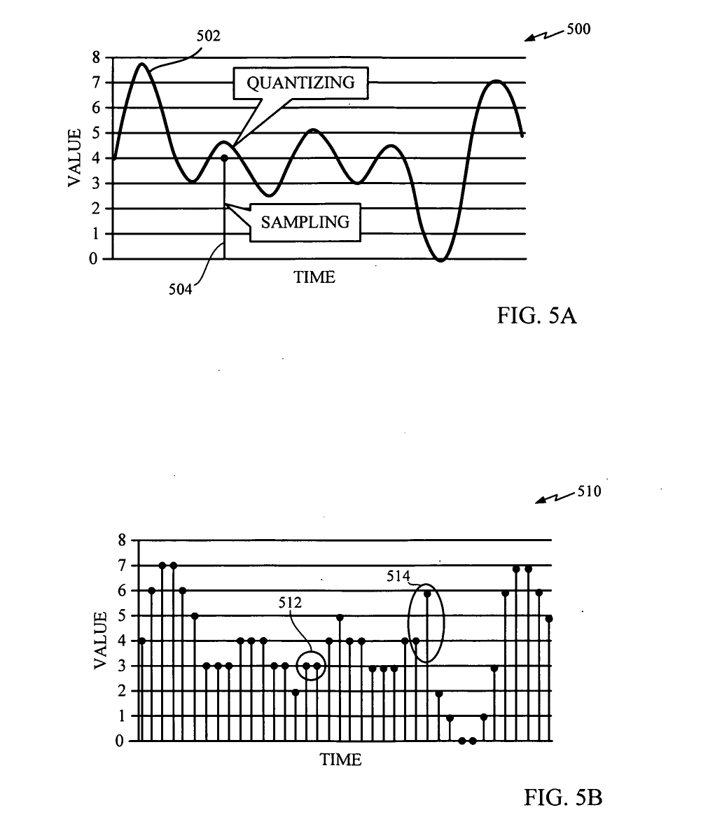

FIG. 5A is a graph 500 illustrating sampling and quantization of an audio signal 502, such as speech. Sample 504 occurs between values “4” and “5,” and is quantized to a value of “4.”

FIG. 5B is a graph 510 illustrating a plurality of quantized samples associated with audio signal 502 of FIG. 5A. By way of example, a pair of quantized samples 512 may be vector quantized with a two-dimensional quantization into a single cell of FIG. 4 corresponding to x=[3, 3]. Likewise, the pair of quantized samples 514 may be vector quantized into a single cell corresponding to x=[4, 6]. A readily apparent advantage is the ability to transmit and/or store a single codebook index i associated with a pair of values. Hence, a two-fold increase in compression is provided when compared with scalar quantization. With further reference to FIG. 5B it also becomes readily apparent that a three-dimensional vector, composed of three quantized samples, could be associated with a three-dimensional codebook, and so on. Likewise, the audio data of FIG. 5B could be replaced with image data, video data, or other parameters associated with original signal data. An example of other parameters would be linear predictive coding parameters (“LPCs”) which are used in speech coding.

As vector size increases, mathematical representations are generally used in place of visual conceptualization. Moreover, various algorithms have been developed for enhancing codebook search. However, most codebook designs provide for clustering of data around a centroid. A popular codebook training algorithm is the K-means algorithm, defined as follows:

Given an iteration index of m, with Cᵢ being the i^{th} cluster at iteration m, with yᵢₘ being the centroid:
1. Initialization: Set m=0 and choose a set of initial codebook vectors yᵢ₀, 1≦i≦L.
2. Classification: Partition the set of training vectors xₙ, 1≦n≦M, into the clusters Cᵢ by the nearest neighbor rule,

xεCᵢₘ if d[x, yᵢₘ]≦d[x, yⱼₘ] for all j≠i. EQ. 3
3. Codebook updating: m→m+1. Update the codebook vector of every cluster by computing the centroid of training vectors in each cluster.
4. Termination test: If a decrease in overall distortion at iteration m relative to m−1 is below a certain threshold, stop; otherwise, go to step 2.

The K-means algorithm is generally described by Kondoz, A. M. in “Digital Speech, Coding for Low Bit Rate Communication Systems,” second edition, 2004, John Wiley & Sons, Ltd., ch. 3, pp. 23-54. The K-means algorithm converges to a local optimum and is generally executed in real time to achieve an optimal solution. However in general, any such solution is not unique. Codebook optimization is generally provided by initializing codebook vectors to different values and repeating for several sets of initializations to arrive at a codebook that minimizes distortion. It is generally accepted that computation and storage requirements associated with a full codebook search are exponentially related to the number of codeword bits. Furthermore, because codeword selection is usually provided by cross-correlating an input vector with codewords, exhaustive real time codebook searching requires a large number of multiply-add operations. Accordingly, efforts have been undertaken to reduce computational complexity, which translates into increases in processor efficiency and reductions in power consumption. In the art of speech and video processing, reduced power consumption translates into increased battery life for hand-held units, such as laptop computers and wireless handsets.

As an improvement to the exhaustive K-means algorithm, a binary search methodology, also known as hierarchical clustering, has been developed. A well known technique for binary clustering was provided by Buzo, A., et al., in “Speech Coding Based Upon Vector Quantization,” IEEE Transactions on Acoustics, Speech and Signal Processing (“ASSP”), vol. 28, no. 5, October 1980, pp. 562-574. This technique is referred to as “the LBG algorithm” based on a paper by Linde, Buzo, and Gray, entitled “An Algorithm for Vector Quantizer Design,” in IEEE Transactions on Communications, vol. 28, no. 1, January 1980, pp. 84-95. While the LBG algorithm was related to quantizing 10-dimensional vectors in a Linear Predictive Coding (“LPC”) system, the technique may be generalized as follows.

In a binary search codebook, an N dimensional space is first divided into two regions, for example using the K-means algorithm with two initial vectors. Then, each of the two regions is further divided into two sub-regions, and so on, until the space is divided into L regions or cells. Hence, L is a power of 2, L=2^{B}, where B is an integer number of bits. As above, each region is associated with a centroid. At the first binary division, new vectors v₁ and v₂ are calculated as the centroids of the two halves of the total space. At the second binary division, v₁ is divided into two regions each having vectors calculated as centroids v₃ and v₄. Likewise, vector v₂ is divided into two regions each having vectors calculated as centroids v₅ and v₆ and so on, until regions having centroids associated with the K-means clusters are obtained. Because the input vector x is compared against only two candidates at a given time, computation cost is a linear function of the number of bits in the codewords. On the other hand, additional centroids must be pre-calculated and stored within the codebook, thereby adding to storage requirements. A variant of the binary search codebook may also be constructed such that each vector from a previous stage points to more than two vectors at a current stage. The trade off is between computation cost and storage requirements.

The K-means algorithm is distinguishable from the binary search methodology in that for the K-means algorithm, only the training sequence is classified. In other words, the K-means algorithm provides that a sequence of vectors are grouped in a low distortion manner (which is computationally efficient for grouping), but the quantizer is not produced until the search procedure is completed. On the other hand in a binary search or “cluster analysis” methodology, the goal is to produce a time-invariant quantizer path constructed from pre-calculated centroids that may be used on future data outside of the training sequence.

Other types of codebooks set forth in the literature are adaptive codebooks and split-vector codebooks. In an adaptive codebook, a second codebook is used in a cascade fashion with another codebook, such as a fixed codebook. The fixed codebook provides the initial vectors, whereas the adaptive codebook is continually updated and configured in response to the input data set, such as particular parameters corresponding to an individual's speech. In a split codebook methodology, also known as split vector quantization or split-VQ, an N dimensional input vector is first split into a plurality of sections, with separate codebooks used to quantize each section of the N dimensional input vector. However, a common characteristic of the above types of codebooks is that a measure of distortion is performed in order to select determine a corresponding codeword or appropriate centroid along a search path.

Naturally occurring signals, such as speech, geophysical signals, images, etc., have a great deal of inherent redundancies. Such signals lend themselves to compact representation for improved storage, transmission and extraction of information. Vector quantization is a powerful technique for efficient representation of one and multidimensional signals. It can also be viewed as a front end to a variety of complex signal processing tasks, including classification and linear transformation. Once an optimal vector quantizer is obtained, under certain design constraints and for a given performance objective, very significant gains in performance are achieved.

Vector quantization techniques have been successfully applied to various signal classes, particularly sampled speech, images, video etc. Vectors are formed either directly from the signal waveform (“Waveform Vector Quantizers”) or from Linear Predictive (“LP”) model parameters extracted from the signal (mode based Vector Quantizers). Waveform vector quantizers often encode linear transform, domain representations of the signal vector or their representations using multi-resolution wavelet analysis. The premise of a model based signal characterization is that a broadband, spectrally flat excitation is processed by an all pole filter to generate the signal. Such a representation has useful applications including signal compression and recognition, particularly when vector quantization is used to encode the model parameters.

Vector quantization codebook searching can occur in many fields. Below, vector quantization is sometimes described in terms of mobile communication. However, vector quantization is not limited mobile communication, as it can be applied to other applications, e.g., video coding, speech coding, speech recognition, etc.

As described above, an excitation waveform codebook comprises a series of excitation waveforms. However, during speech encoding, performing codebook searches can require intensive computational and storage requirements, especially for large codebooks. One embodiment is a system and method that provides an improved vector quantization codebook search using support vector machines (“SVMs”) to perform faster codebook searches using less resources. SVMs are a set of related supervised learning methods used for classification. In one embodiment, codebook waveforms are separated into multiple bins. During a codebook search, a determination is made which bin holds the proper excitation waveform, and then only that bin is searched. By separating the codebook into two or more bins, or subsections, the search complexity can be reduced because fewer than all the codebook waveforms need to be searched.

According to an embodiment, while offline, a controller computes a linear separable hyperplane of the codebook using SVMs, then separates codebook elements into a plurality of bins (e.g., two bins, four bins, eights bins, etc.) using the hyperplane derived from SVMs. There are many linear classifiers (e.g., hyperplanes) that can be used to separate the given codebook elements into multiple bins. The hyperplane computed from SVMs achieves a maximum separation between the bins. This separation provides that the nearest distance between a codebook element on one side of the hyperplane and a codebook element on the other side of the hyperplane is maximized. With this large distance between elements of each bin, there may be less error in classifying elements into one of the classes or bins.

In another embodiment, the codebook elements are separated by computing an average partition value in one dimension, not a hyperplane, and then separating the codebook elements into bins around the average partition value.

During mobile communication (i.e., run-time), the vocoder or controller search process determines which bin contains a desired speech codebook element based on the speech pattern of the speaker at that time. Once the search process determines the proper bin containing the desired codebook element, the process searches all the elements in that bin for a minimum mean square error to find the desired codebook element. This results in a greatly reduced search burden because the controller is not required to search the entire codebook, just the appropriate bin, which is a subsection of the entire codebook. Also, search complexity is reduced since the codebook elements are static, and thus the hyperplane can be computed once off-line and then used multiple times during run-time for searching.

In a full search codebook, the codevectors are randomly positioned. The search amounts to a minimum distortion calculation between the input speech target vector and every codevector in the codebook. The search complexity is proportional to N. A binary codebook partitions the codevectors into clusters based on the distance to a centroid defined for each cluster. This clustering is done pre-search so that the codebook can be arranged to take advantage of a more efficient search. The search complexity is proportional to log₂N at the expense of increased memory requirements to store the centroid nodes.

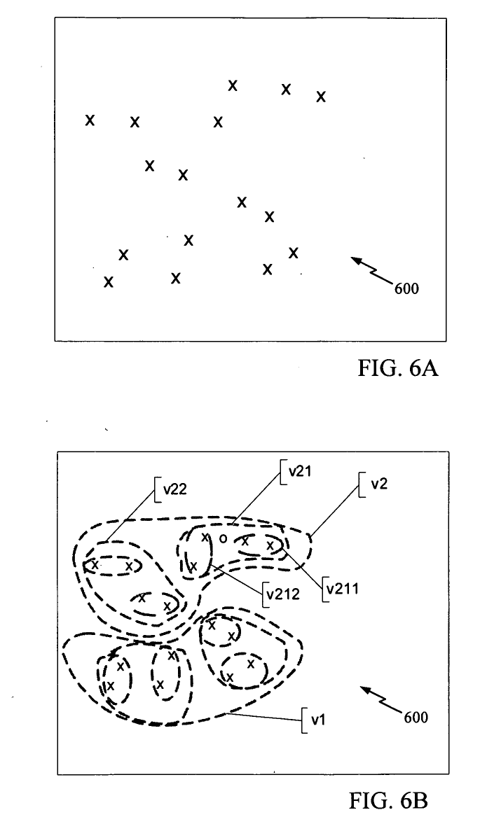

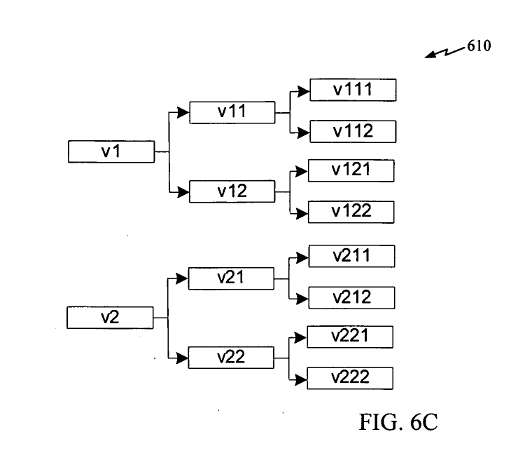

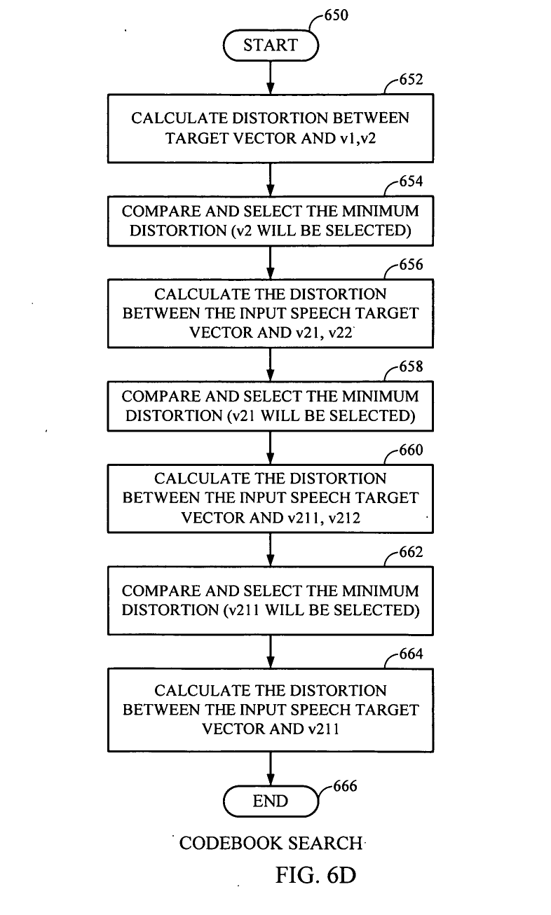

FIGS. 6A illustrates representative data 600 to be quantized and FIG. 6B illustrates data 600 partitioned into clusters. Example clusters are [v1, [v2, [v21, [v22, [v211, and [v212. The partitions are determined based on the distance of the codevectors to the corresponding cluster centroids. The centroid vectors are stored as nodes in the codebook and used in the search algorithm to traverse through a path (i.e., a branch) in the codebook (i.e., the tree).

FIG. 6C illustrates a search tree diagram corresponding to a search for the target input vector “o” in FIG. 6B. Variables denoted by v1, v2, etc. represent the centroid node in the binary tree, wherein variables of FIG. 6C correspond to clusters in FIG. 6B.

FIG. 6D illustrates a flow diagram corresponding to a search for target input vector “o” in FIGS. 6B and 6C. In operation 652, the distortion between the input speech target vector and v1 and the distortion between the input speech target and v2 is calculated. In operation 654, compare and select the minimum distortion (v2 will be selected).

In operation 656, calculate the distortion between the input speech target vector and v21 and the distortion between the input speech target and v22. In operation 658 compare and select the minimum distortion (v21 will be selected).

In operation 660, calculate the distortion between the input speech target vector and v211 and the distortion between the input speech target and v212. In operation 662, compare and select the minimum distortion (v211 will be selected).

In operation 664, calculate the distortion between the input speech target vector and the codevectors associated with v211.

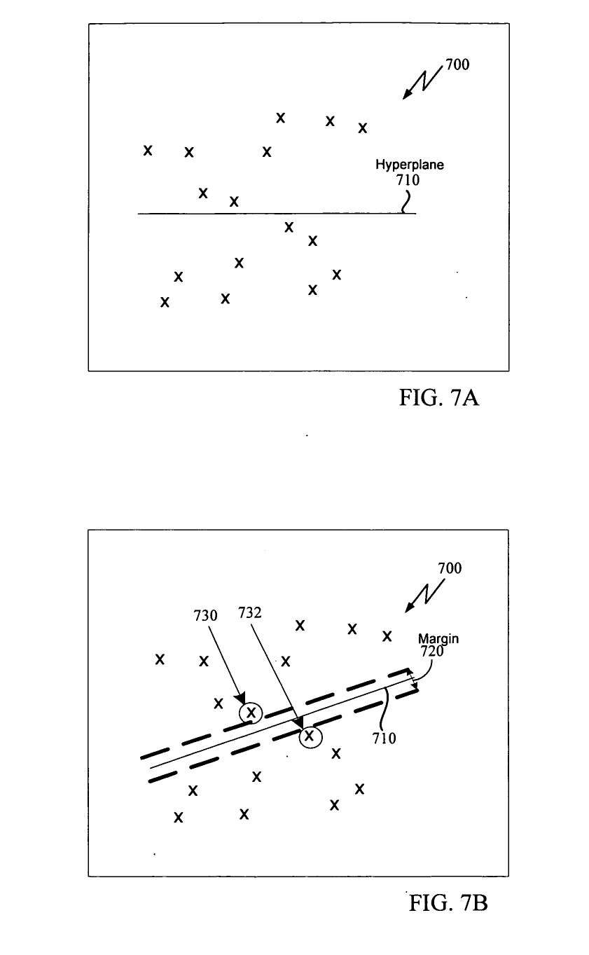

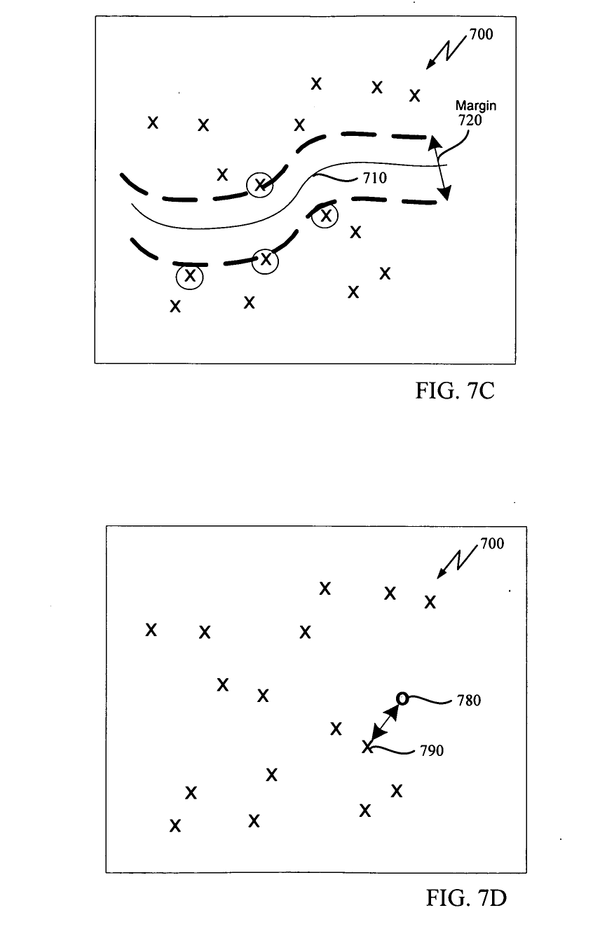

FIG. 7A illustrates representative codebook data 700 in a codebook that can be partitioned using hyperplane 710 and support vectors. The support vectors are not clustered based on minimum distance criterion as in the binary search codebook above. Instead, the support vectors are classified into two categories based on a predetermined criterion and the hyperplane is calculated to thereby separate the support vectors into bins.

FIG. 7B illustrates codebook data 700 with a margin 720 defined as a distance from the hyperplane to support vectors 730 and 732. The hyperplane 710 is determined by finding the equation for a curve which maximizes the margin.

FIG. 7C illustrates codebook 700 with a more optimum hyperplane 710 than FIG. 7B. FIG. 7D illustrates that when a function (hyperplane) determines the partition instead of a single point (centroid), the search error is reduced. For example, FIG. 7D represents a target vector 780 and the support vector 790 that should be chosen in the search based on a minimum distance.

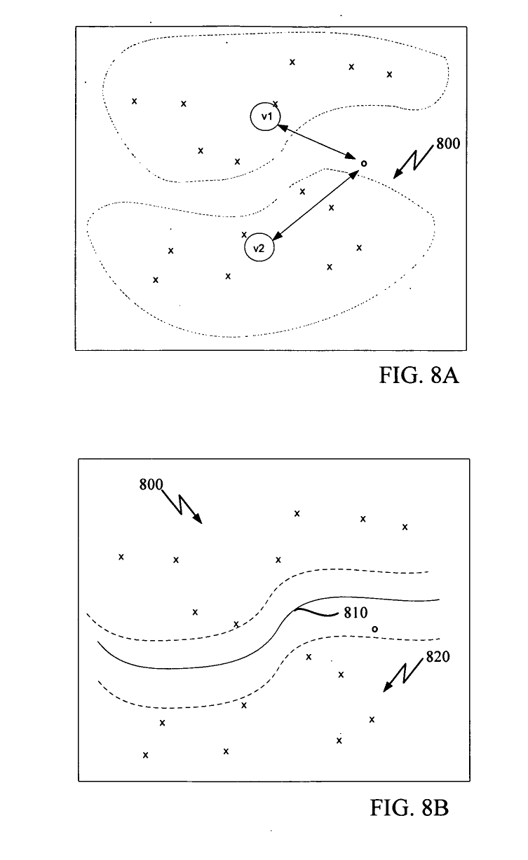

FIG. 8A illustrates a representative first minimum distance calculation in a search of binary codebook data 800. In this case the cluster associated with v1 would be chosen due to the smaller distance. FIG. 8B illustrates selection of a support vector set 820 positioned below a hyperplane 810 in binary codebook data 800.

Thus, once a VQ codebook is trained by means of K-means or LBG algorithms, set forth above, exhaustive search of the entire codebook is performed for any input vector to be quantized. Accordingly, exhaustive search of the codebook is avoided.

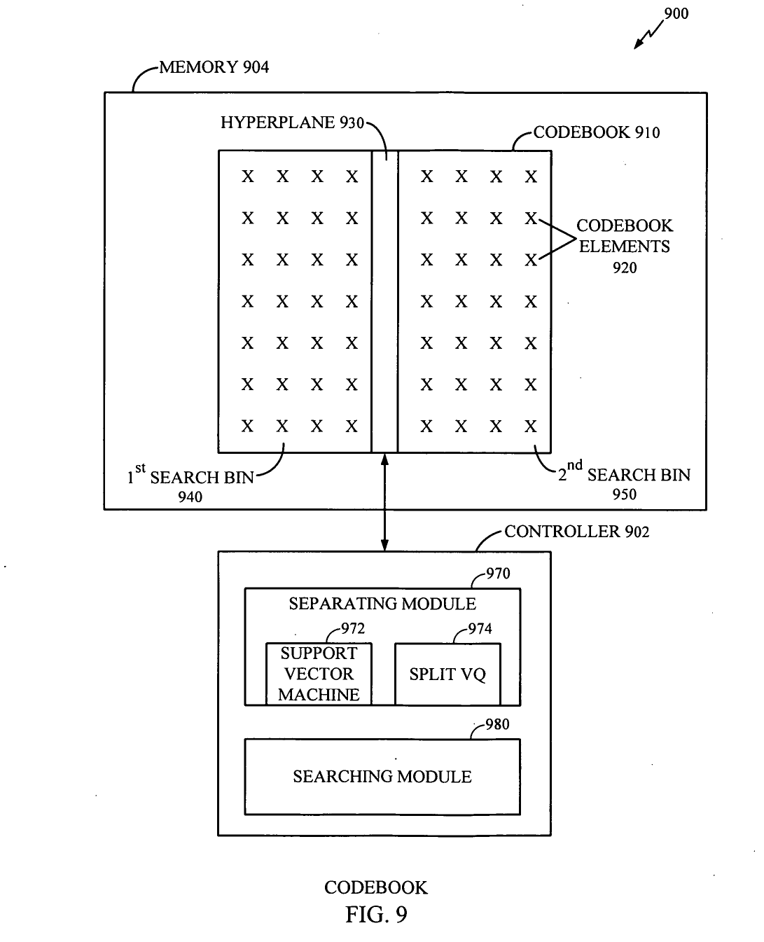

FIG. 9 is a block diagram illustrating a processing device 900 including a controller 902 coupled to a memory 904. According to embodiments, processing device 900 may be an image processing device, a video processing device, or a speech processing device, such as a wireless handset. Alternately, processing device 900 can include, among other devices, a hands free car phone system, landline houseline phone, conference calling phone, cell phone, installed room system which uses ceiling speakers and microphones on the table, mobile communication devices, bluetooth devices, and teleconferencing devices, etc. In one embodiment, processing device 900 operates on a GSM, UMTS, or CDMA type of wireless network.

As illustrated, memory 904 stores a codebook 910. The codebook 910 comprises codebooks elements 920 representing static excitation waveforms or elements. The codebook elements 920 comprise input code vectors representing voice parameters. Thus, the codebook 910 provides one means for providing a plurality of codebook elements 920. In this embodiment, the codebook 910 is illustrated with a first search bin 940 and a second search bin 950, where the search bins are separated by a hyperplane 930.

The hyperplane 930 separates the codebook elements 920 into a plurality of bins. In the illustrated embodiment, the hyperplane 930 divides codebook 910 into two bins 940 and 950. However, in other embodiments, the codebook can be further partitioned into four bins, eight bins, sixteen bins, etc. By separating the codebook elements 920 into a plurality of bins, each bin contains less than all of the codebook elements. In one embodiment, codebook elements that are close to the hyperplane are placed in both bins to reduce classification errors. In the illustrated embodiment, bins 940 and 950 each contain approximately half, or slightly more than half, of the codebook elements. As a result, codebook elements in one of two bins can be searched approximately twice as fast as if all the codebook elements were searched.

The hyperplane 930 is computed from at least one separating module 970 in the controller 902. In one embodiment, the separating module 970 is a support vector machine (“SVM”) 972. Thus, the SVM 972 provides one means for computing a hyperplane from the plurality of codebook elements. The SVM comprises a set of methods for classification and regression of data points such as codebook elements. As such, the SVM 972 minimizes classification error by maximizing the geometric margin between data on each side of the hyperplane. The SVM 972 is able to create the largest possible separation or margin between codebook elements in each of the classes (i.e., bins). Thus, separating module 970 provides one means for separating the codebook elements into a first search bin and a second search bin.

Mathematically, the computation of a hyperplane by the SVM 972 to maximize separation or margin is explained generically by considering a set of training data, of the form {(x₁, c₁), (x₂, c₂), (x₃, c₃), . . . , (xₙ, cₙ)}. In the training data, cᵢ is either positive one or negative one, denoting the class or bin to which data point xᵢ belongs, and xᵢ is an “n” dimensional real vector. This training data (xᵢ, cᵢ) denotes the desired classification which the SVM should eventually distinguish by. The SVM accomplishes this classification by dividing the training data points by a partition such as a dividing hyperplane. The hyperplane takes the mathematical form of: w·xᵢ−b=0, where w is a input vector perpendicular to the hyperplane, and b is an offset parameter that determines the hyperplane's offset from the origin along the normal vector w, allows the margin to be increased, avoids requiring the hyperplane to be passed through the origin.

To maximize separation, the SVM computes a parallel hyperplane that is closest to the codebook vectors. A parallel hyperplane is described by the following equations: wxᵢ−b=1 and wxᵢ−b=−1. If the training data (xᵢ, cᵢ) is linearly separable, then the SVM can compute the hyperplane with no points between the training data, which maximizes the separation distance. To accomplish this, the SVM minimizes the value of support vector w while still retaining the hyperplane equations above. Two solutions for support vector w have been computed. First, the primal form, is the quadratic program optimization of ½ ŵ2 subject to cᵢ (wxᵢ−b≧1) for i between 1<i≦n. Second, the dual form, w=(sum of) αᵢ cᵢ xᵢ for i ranging from 1 to n. As such, the above equations are solved for a given set of codebook elements or entries to find the hyperplane that maximizes separation.

The SVM embodiment reduces search complexity of codebook search in any speech codec. All elements in the codebook can be separated or segregated into two or more bins using a linear separable hyperplane derived from support vector machines. To reduce search errors resulting from classification errors, codebook entries or elements that are close to the hyperplane can be included into more than one bin.

In another embodiment, the separating module 970 is a split vector quantization (“SVQ”) structure. The SVQ structure divides each codebook vector into two or more sub-vectors, each of which are independently quantized subject to a monotonic property. Splitting reduces the search complexity by dividing the codebook vector into a series of sub-vectors.

The separation can occur in any number of dimensions, including one-dimension to 16 dimensions. In one dimension, a point partition is one dimensional line. In two dimensions, a line partition is a two dimensional plane. In three dimensions, a plane partition is a three dimensional surface. SVQ reduces the dimension of data. Thus, the separating module 970, such as SVQ, and the computation of the hyperplane 930 can be performed offline, and then used during run time.

SVQ may be applied to techniques associated with linear predictive coding (“LPC”). LPC is a well-established technique for speech compression at low rates. In order to achieve transparent quantization of LPC parameters, typically 30 to 40 bits are required in scalar quantization. Vector quantization (“VQ”) can reduce the bit rate to 10 bits/frame, but vector coding of LPC parameters at such a bit rate introduces large spectral distortion that can be unacceptable for high-quality speech communications. In the past, structurally constrained VQs such as multistage (residual) VQs and partitioned (split) VQs have been proposed to fill the gap in bit rates between scalar and vector quantization. In multistage schemes, VQ stages are connected in cascade such that each of them operates on the residual of the previous stage. In split vector schemes, the input vector is split into two or more subvectors, and each subvector is quantized independently. Recently, transparent quantization of line spectrum frequency (“LSF”) parameters has been achieved using only a 24 bit/frame split vector scheme.

Also shown in FIG. 9 is a searching module 980. Searching module 980, performed during run time, can determine which bin contains the desired speech codebook element. Thus, search module 980 provides one means for determining whether a desired codebook element is in the first search bin or the second search bin. The search module 980 can accomplish this by defining the first search bin 940 as having a positive result based on an input vector, and the second search bin 950 having a negative result based on the input vector. After determining which bin contains the desired codebook element, the searching module 980 searches that bin for the desired codebook element. Thus, searching module 980 provides one means for searching for the determined search bin for the desired codebook element. In one embodiment, the searching module 980 comprises a vector quantization codebook search. In another embodiment, the searching module 980 searches the codebook element for a minimum mean square error.

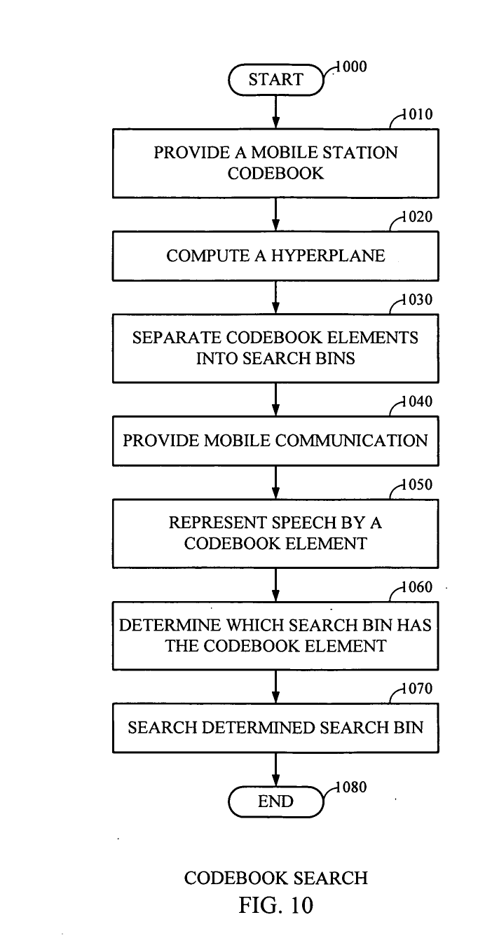

FIG. 10 is a flow diagram illustrating a process of searching a codebook. The process starts at operation 1000. At operation 1010, a mobile station codebook is provided. The codebook comprises a plurality of codebook elements representing characteristics of a speaker's voice. Subsequently, at operation 1020, the process computes a linear separable hyperplane. In one embodiment, the SVM computes the hyperplane in the codebook from the plurality of codebook elements, where the hyperplane forms two search bins in the codebook. Although in one embodiment the codebook is partitioned into two search bins, in other embodiments the codebook can be further partitioned into four bins, eight bins, sixteen bins, etc. Next, the process in operation 1030 separates the codebook elements into the search bins. Although some codebook element may be placed in multiple search bins for redundancy and to reduce errors, each search bin contains less than all of the codebook elements. This enables faster searching with fewer resources than if all of the codebook elements are searched.

Proceeding to operation 1040, a mobile communication conversation is ongoing. Next, the process in operation 1050 represents speech of one of the mobile station's speakers by a codebook element. During the mobile communication, instead of sending the actual voice parameters, vectors representing the actual voice parameters are sent instead. Then, the process in operation 1060 determines which search bin has the particular speech codebook element corresponding to the speaker's voice. At operation 1070, the process searches the determined search bin for particular speech codebook element. This search can be accomplished by searching for a minimum mean squared error. The process ends at operation 1080.

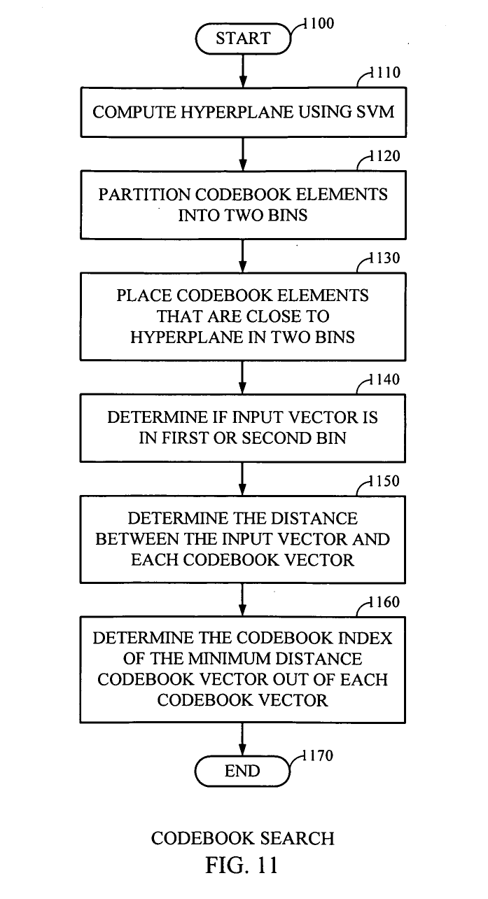

FIG. 11 is a flow diagram illustrating a process of searching a codebook in Adaptive Multirate WideBand (“AMR-WB”) Speech Codec. AMR-WB extends the audio bandwidth to 7 kHz and gives superior speech quality and voice naturalness compared to existing codecs in fixed line telephone networks and in second- and third-generation mobile communication systems. The introduction of AMR-WB to GSM and Wideband Code Division Multiple Access (“WCDMA”) third generation (“3G”) systems brings a fundamental improvement of speech quality, raising it to a level never experienced in mobile communication systems before. It far exceeds the current high quality benchmarks for narrow-band speech quality and changes the expectations of a high quality speech communication in mobile systems. The good performance of the AMR-WB codec has been made possible by the incorporation of novel techniques into the Algebraic Code Excited Linear Prediction (“ACELP”) model in order to improve the performance of wideband signals.

The process starts at operation 1100. At operation 1110, the process computes a hyperplane in the f(x)=ax+b, where x is a given input vector, and a and b are constants. In one embodiment, the SVM computes a hyperplane. In another embodiment, a linear classifier other than a hyperplane is computed. In one embodiment, an average partition value is computed. Proceeding to operation 1120, the hyperplane is used while offline to partition codebook elements into two bins. In one embodiment, a linear separable hyperplane is used. In operation 1130, the codebook elements that are close to the hyperplane are placed in multiple bins to reduce classification errors.

Continuing to operation 1140, the search algorithm determines which bin contains the given input vector, before searching for the minimum error. Mathematically, if f(x)>0, the input vector is in the first bin, whereas if f(x)<0, then the input vector is in the second bin. Next, in operation 1150 the search algorithm determines the distance between the input vector and each codebook vector in the codebook. At operation 1160, the search algorithm finds and returns the codebook index of the minimum distance codebook vectors out of all the codebook vectors. The process ends at operation 1170.

Pseudo code for the improved search algorithm corresponding to at least searching operations 1140 to 1170 of FIG. 11 is provided so those skilled in the art can better understand the codebook searching. Computation of the hyperplane using SVMs that achieves maximum separation between the codebook entries was explained above in FIG. 9. Once this hyperplane that separates codebook entries is computed, the following optimized search algorithm is used to perform a search with reduced complexity. The hyperplane for a two dimensional codebook is of the following form:

```
f(x) = (w0*x(0)+w1*x(1)−b)
    x = input code vector; dist_min = 0x7FFFFFFF; p_dico = dico;
    index = 0; code
    book size = 64; index1 = 0;
    /* dico - Codebook starting address*/
    /* the hyperplane is defined as f(x) =
    (0.04546*x[0] −0.000514*x[1] −12.515) */
result = (0.04546*x[0] −0.000514*x[1] −12.515);
If (result > 0) /* “codebook_positive” contains only codebook
entries, and its indices which falls on positive side of hyperplane */
    p_dico = &codebook_positive[0]; dico_size = 32;
    Else if /* “codebook_negative” contains only codebook entries,
    and its indices which falls on negative side of hyperplane */
    p_dico = &codebook_negative[0]; dico_size = 32;
Endif
p_dico1 = p_dico;
For i = 0 to code book size
    set dist to 0;
    For j = 0 to dim
        temp = (x[j] − *p_dico++);
        dist = dist + (temp*temp);
    Endfor
    if (dist − dist_min) < 0)
        dist_min = dist; index1 = i; /* get the original
        code book index from this index. */
        Index = *p_dico++;
        Else if
            *p_dico++;
    End if
End for
    *distance = dist_min; /* Reading the selected vector */
    p_dico = &p_dico1[index1 * dim]
    For j = 0 to dim
    x[j] = *p_dico++;
    End for
Return index;
```

The above pseudo code efficiently determines which bin contains the input vector, and then searches that bin. For comparison, a normal method for determining the minimum distance vector index in AMR-WB Speech Codec is provided below. First, this method finds the distance between the input vector and each codebook vector in the codebook. Second, the method finds the codebook index of minimum distance codebook vector among all codebook vectors.

```
x = input code vector; /* dico - Codebook starting address*/
dist_min = 0x7FFFFFFF; /* p_dico = codebook address;*/
p_dico = &codebook[0]; index = 0; code book size = 64; index1 = 0;
For i = 0 to code book size
    set dist to 0;
For j = 0 to dim
    temp = (x[j] − *p_dico++); dist = dist + (temp*temp);
Endfor
    if (dist − dist_min) < 0)
        dist_min = dist;
        index = i;
    End if
End for
*distance = dist_min; /* Reading the selected vector */
p_dico = &codebook[index * dim]
For j = 0 to dim
    x[j] = *p_dico++;
End for
Return index;
```

Below in Table 1 are test results from the improved codebook searching method in two and three dimensions showing the improved efficiency. In this embodiment, the separating modules used are SVM and SVQ. As a result, the number of cycles to obtain the desired input vector was reduced between 17% and 58%.

TABLE 1
Results of Codebook Searches

| | | | | Best case | % of | |
|---|---|---|---|---|---|---|
| | | | Total | cycles | Cycles | |
| | | | cycles for | savings for | savings | |
| Name of | Codebook | Codebook | codebook | codebook | with full | Best or |
| Codebook | dimension | size | search | search | search | Worst case |
| dico1_isf_noise | 2 | 64 | 64(2 * 2 + 3) | 37(2 * 2 + 3) | 58% | Best Case |
| dico3_isf_noise | 3 | 64 | 64(3 * 2 + 6) | 29(3 * 2 + 6) | 45% | Best Case |
| dico1_isf_noise | 2 | 64 | 64(2 * 2 + 3) | 37(2 * 2 + 3) | 30% | Worst |
| | | | | | | Case |
| dico3_isf_noise | 3 | 64 | 64(3 * 2 + 6) | 11(3 * 2 + 6) | 17% | Worst |
| | | | | | | Case |

It is appreciated by the above description that the described embodiments provide codebook searching in mobile stations. According to one embodiment described above, codebook searching is provided for a dual-mode mobile station in a wireless communication system. Although embodiments are described as applied to communications in a dual-mode AMPS and CDMA system, it will be readily apparent to a person of ordinary skill in the art how to apply the invention in similar situations where codebook searching is needed in a wireless communication system.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the embodiments disclosed herein may be embodied directly in a computer or electronic storage, in hardware, in a software module executed by a processor, or in a combination thereof A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a mobile station. In the alternative, the processor and the storage medium may reside as discrete components in a mobile station.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
a codebook comprising a plurality of codebook elements, wherein the elements are separated into a first search bin and a second search bin; and
a searching module configured to determine whether a desired codebook element for an input vector is in the first search bin or the second search bin.

2. The apparatus of claim 1, wherein the codebook elements are further separated into a third search bin and a fourth search bin.

3. The apparatus of claim 1, wherein the apparatus comprises a wireless telephone.

4. The apparatus of claim 1, wherein the elements were separated into a first search bin and a second search bind using a support vector machine.

5. The apparatus of claim 4, wherein the support vector machine is configured to compute a linear classifier from the plurality of codebook elements, wherein the linear classifier is a hyperplane.

6. The apparatus of claim 5, wherein the hyperplane is a linear separable hyperplane.

7. The apparatus of claim 1, wherein the searching module comprises a vector quantization codebook search and the codebook elements represent signal parameters.

8. The apparatus of claim 1, wherein the searching module searches the plurality of codebook elements for a minimum mean square error or other error metrics.

9. The apparatus of claim 1, wherein the codebook elements comprise input code vectors representing voice parameters.

10. A method of searching a codebook comprising:
providing a mobile station codebook with a plurality of codebook elements, wherein the codebook elements are separated into a first search bin and a second search bin;
determining whether a desired codebook element for an input vector is in the first search bin or the second search bin; and
searching the determined search bin for the desired codebook element.

11. The method of claim 10, wherein the elements were separated into a first search bin and a second search bind using a support vector machine.

12. The method of claim 11, wherein the support vector machine is configured to compute a linear classifier from the plurality of codebook elements, wherein the linear classifier is a hyperplane.

13. The method of claim 10, wherein the searching module comprises a vector quantization codebook search and the codebook elements represent signal parameters.

14. The method of claim 10, wherein the codebook elements comprise input code vectors representing voice parameters.

15. A computer readable medium containing software that, when executed, causes the computer to perform the acts of:
providing a mobile station codebook with a plurality of codebook elements, wherein the codebook elements are separated into a first search bin and a second search bin;
determining whether a desired codebook element for an input vector is in the first search bin or the second search bin; and
searching the determined search bin for the desired codebook element.

16. The computer readable medium of claim 15, wherein the elements were separated into a first search bin and a second search bind using a support vector machine.

17. The computer readable medium of claim 16, wherein the support vector machine is configured to compute a linear classifier from the plurality of codebook elements, wherein the linear classifier is a hyperplane.

18. The computer readable medium of claim 15, wherein the searching module comprises a vector quantization codebook search and the codebook elements represent signal parameters.

19. The computer readable medium of claim 15, wherein the codebook elements comprise input code vectors representing voice parameters.

20. A device, comprising:
means for providing a mobile station codebook with a plurality of codebook elements, wherein the codebook elements are separated into a first search bin and a second search bin;
means for determining whether a desired codebook element for an input vector is in the first search bin or the second search bin; and
means for searching the determined search bin for the speech codebook element.

21. The device of claim 20, wherein the elements were separated into a first search bin and a second search bind using a support vector machine.

22. The device of claim 21, wherein the support vector machine is configured to compute a linear classifier from the plurality of codebook elements, wherein the linear classifier is a hyperplane.

23. The device of claim 20, wherein the searching module comprises a vector quantization codebook search and the codebook elements represent signal parameters.

24. The device of claim 21, wherein the codebook elements comprise input code vectors representing voice parameters.

25. A codebook product configured according to a process comprising:
providing a plurality of codebook elements, wherein the codebook elements are separated into a first search bin and a second search bin;
determining whether a speech desired codebook element for an input vector is in the first search bin or the second search bin; and
searching the determined search bin for the speech desired codebook element.

26. The codebook product of claim 25, wherein the elements were separated into a first search bin and a second search bind using a support vector machine.

27. The codebook product of claim 26, wherein the support vector machine is configured to compute a linear classifier from the plurality of codebook elements, wherein the linear classifier is a hyperplane.

28. The codebook product of claim 27, wherein the searching module comprises a vector quantization codebook search and the codebook elements represent signal parameters.

29. The codebook product of claim 25, wherein the codebook elements comprise input code vectors representing voice parameters.
